(19) United States
(12) Patent Application Publication
(10) Pub. No.: US 2025/0322112 A1
(43) Pub. Date: Oct. 16, 2025

(54) METHOD AND DEVICE FOR PROVIDING DRAWING INFORMATION FOR DESIGN COLLABORATION

(71) Applicant: IUCF-HYU (INDUSTRY-UNIVERSITY COOPERATION FOUNDATION HANYANG UNIVERSITY), Seoul (KR)

(72) Inventors: Kyung Hoon HYUN, Seoul (KR); Ho Young MAENG, Seoul (KR)

(21) Appl. No.: 19/215,092

(22) Filed: May 21, 2025

Related U.S. Application Data
(63) Continuation of application No. PCT/KR2023/018668, filed on Nov. 20, 2023.

(30) Foreign Application Priority Data
Nov. 24, 2022 (KR) 10-2022-0159332

(51) Int. Cl. G06F 30/13; G06F 30/27; G06F 111/02

(52) U.S. Cl. CPC G06F 30/13; G06F 30/27; G06F 2111/02

(57) ABSTRACT

Disclosed are a method and a device for providing drawing information, which may support a collaboration with respect to a drawing design of a designer. The disclosed method for providing drawing information for a design collaboration includes the steps of: providing drawing images searched according to search request information of a user to the user; storing, in a search record folder, at least one drawing image selected by the user among the searched drawing images; generating a representative image with respect to the drawing image stored in the search record folder; and providing the representative image to the user.

### CROSS-REFERENCE TO RELATED APPLICATIONS

This application is a bypass continuation of pending PCT International Application No. PCT/KR2023/018668, which was filed on Nov. 20, 2023, and which claims priority from Korean Patent Application No. 10-2022-0159332 filed on Nov. 24, 2022. The entire contents of the aforementioned patent applications are incorporated herein by reference.

### BACKGROUND

### 1. Technical Field

The present disclosure relates to a method and device for providing drawing information for design collaboration.

### 2. Description of the Related Art

The importance of design collaboration has increased as the demand for high time efficiency in solving design problems and the complexity of design itself increases.

Design collaboration systems are being studied to support a collaborative environment where users can share visual information and explore ideas.

However, existing design collaboration systems only focus on how to promote interaction between designers, communication methods, etc. In the design collaboration process, in addition to the aforementioned interaction and communication, it is important to provide reference designs that can be referenced in the design process and provide inspiration to designers, and therefore, there is a need for a method to effectively provide reference designs to the design collaboration process.

### SUMMARY OF THE INVENTION

The present disclosure is to provide a method and device for supporting design collaboration of designers.

In particular, the present disclosure is to provide a method and device for providing drawing information that can support collaboration of designers on drawing design.

According to one embodiment of the present disclosure, conceived to achieve the objectives above, a method for providing drawing information for design collaboration is provided, including the steps of: providing drawing images searched according to search request information of a user to the user; storing, in a search record folder, at least one drawing image selected by the user among the searched drawing images; generating a representative image with respect to the drawing image stored in the search record folder; and providing the representative image to the user.

In addition, according to another embodiment of the present disclosure, conceived to achieve the objectives above, a method for providing drawing information for design collaboration is provided, including the steps of: providing drawing images searched according to search request information of a user to the user; storing, in a search record folder, at least one drawing image selected by the user among the searched drawing images; generating a preview diagram in which attribute information of the drawing images stored in the search record folder is combined; and providing the preview diagram to the user, wherein the attribute information assigned to the drawing image includes at least one of the number of rooms, a silhouette image, and a connectivity graph, and each of the number of rooms, the silhouette image, and the connectivity graph is attribute information clustered into a plurality of groups according to similarity.

In addition, according to still another embodiment of the present disclosure, conceived to achieve the objectives above, a device for providing drawing information for design collaboration is provided, comprising: a memory; and at least one processor electrically connected to the memory, wherein the processor stores, in a search record folder, at least one drawing image selected by a user among drawing images searched according to search request information of the user, and generates a representative image with respect to the drawing image stored in the search record folder and a preview diagram in which attribute information of the drawing images stored in the search record folder is combined.

According to one embodiment of the present disclosure, design collaboration for a user's drawing design can be supported by providing not only the drawing image for which a user has requested a search, but also a representative image with respect to the drawing image and a preview diagram.

In addition, according to one embodiment of the present disclosure, a preview diagram may be converted into a drawing image and provided to a user, or a drawing image searched by a user may be converted into a new drawing image and provided to the user.

### BRIEF DESCRIPTION OF THE DRAWINGS

FIG. 1 is a drawing for explaining a system for providing drawing information for design collaboration according to one embodiment of the present disclosure.

FIG. 2 is a drawing for explaining a graphic user interface according to one embodiment of the present disclosure.

FIG. 3 is a drawing for explaining a method for providing drawing information for design collaboration according to one embodiment of the present disclosure.

FIG. 4 is a drawing for explaining a method for generating a representative image with respect to a connectivity graph.

FIG. 5 is a drawing for explaining a representative image according to one embodiment of the present disclosure.

FIG. 6 is a drawing for explaining a method for providing drawing information for design collaboration according to another embodiment of the present disclosure.

FIG. 7 is a drawing for explaining a preview diagram according to one embodiment of the present disclosure.

FIG. 8 is a drawing for explaining a drawing image converted from the preview diagram of FIG. 7.

### DETAILED DESCRIPTION OF THE INVENTION

While the present invention is susceptible to various modifications and alternative forms, specific embodiments are shown by way of example in the drawings and described in detail. It should be understood, however, that the description is not intended to limit the present invention to the specific embodiments, but, on the contrary, the present invention is to cover all modifications, equivalents, and alternatives that fall within the spirit and scope of the present invention. The similar reference numerals refer to the similar element in described the drawings.

The present disclosure relates to a method for providing reference design information for design collaboration, and one embodiment of the present disclosure provides information on a drawing design, such as a floor plan, to a user as reference design information.

Design collaboration may be achieved through the process of idea summarization (Idea Summarizer), idea moderation (Idea Moderator), and idea structuring (Idea Structurator). One embodiment of the present disclosure provides an environment in which a user, i.e. a designer, can search for a drawing image that he or she wants to search for, for idea summarization. In addition, one embodiment of the present disclosure processes a drawing image searched by a user and provides the processed drawing image, for idea moderation. Finally, one embodiment of the present disclosure provides an environment in which a user can store a drawing image searched by the user, for idea structuring, and can check various drawing images produced in the process of idea summarization and moderation.

Certain embodiments of the invention will be described below in more detail with reference to the accompanying drawings.

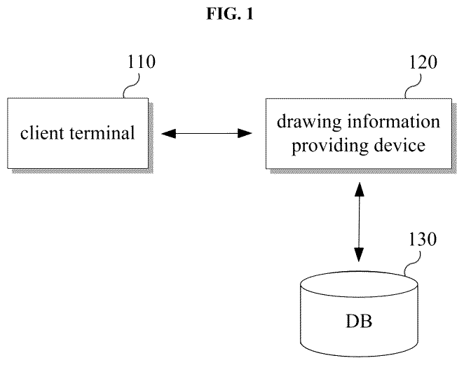

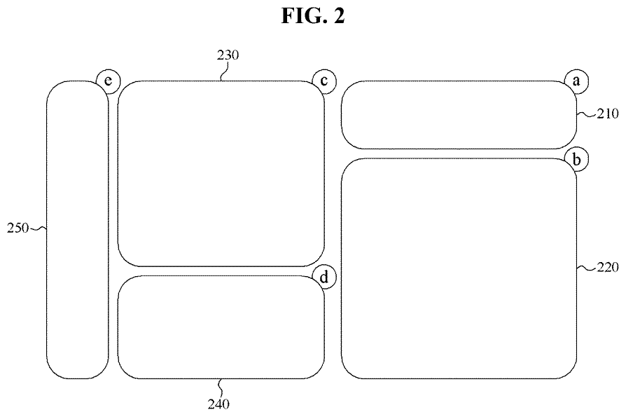

FIG. 1 is a drawing for explaining a system for providing drawing information for design collaboration according to one embodiment of the present disclosure, and FIG. 2 is a drawing for explaining a graphic user interface according to one embodiment of the present disclosure.

A system for providing drawing information according to one embodiment of the present disclosure includes a client terminal 110, a drawing information providing device 120, and a database 130.

A user requests a search for a target drawing image to the drawing information providing device 120 using the client terminal 110. The drawing information providing device 120 searches for reference drawing images stored in a database and provides a drawing image corresponding to the target drawing image to the client terminal 110.

The drawing information providing device 120 may provide drawing information that can be helpful for the user's design collaboration, using the searched drawing images, as well as the drawing images that the user has requested to search for. This drawing information may be a representative image for the drawing images searched for by the user, or a preview diagram generated by combining attribute information of the drawing images.

The attribute information assigned to the drawing image may include at least one of number of rooms (room number), silhouette, and connectivity. Here, the room number means the number of rooms included in the drawing image, the silhouette represents a shape according to an outline of the drawing image, and the connectivity represents a connection relationship between rooms included in the drawing image. The silhouette may be expressed as a vectorized value through a tangent distance, and the connectivity may be expressed as a vectorized value through a GED (Graph Edit Distance) between different pairs of connectivity. Alternatively, in some embodiments, the silhouette attribute information may be expressed in the form of a shape image according to an outline of the drawing image, and the connectivity attribute information may be expressed in the form of a graph consisting of nodes representing rooms and edges connecting the nodes and representing connection relationships between rooms.

Accordingly, a user may request a search for a target drawing image, by transmitting search request information including information on the number of rooms to be searched, silhouette, and connectivity to the drawing information providing device 120. The drawing information providing device 120 compares attribute information of a reference drawing image with attribute information requested by the user for search, and provides a drawing image having a high degree of similarity in attribute information to the client terminal 110.

In addition, attribute information assigned to a drawing image may be clustered into a plurality of groups according to similarity. That is, attribute information corresponding to the same similarity level may be clustered into one group. For clustering, a hierarchical clustering algorithm, a mean shift clustering algorithm, or the like may be used. In this case, the number of clustered groups may vary depending on the embodiment. As the sensitivity level of attribute information increases, the similarity level becomes more detailed, and the number of clustering groups may increase.

The drawing information providing device 120 may include a memory and at least one processor electrically connected to the memory, and the processor performs a series of processes for searching a drawing and providing drawing information to a user. The processor stores at least one drawing image selected by the user among drawing images searched according to the user's search request information in a search record folder, and generates a preview diagram in which a representative image for the drawing image stored in the search record folder and attribute information for the drawing image stored in the search record folder are combined.

As illustrated in FIG. 2, the graphic user interface for providing drawing information, displayed on a client terminal 110, may include a search information input window 210, a search result display window 220, a search history window 230, a feedback provision window 240, and a folder list window 250.

When a user inputs the number of rooms 211, silhouette image 212, and connectivity graph 213 for a target drawing image in the search information input window 210, drawing images searched by the drawing information providing device 120 are displayed in the search result display window 220. A drawing image selected by the user from among the drawing images displayed in the search result display window 220 is displayed in the search history window 230 and stored in the search record folder. A representative image and a preview diagram generated by the drawing information providing device 120 from the drawing image selected by the user are displayed in the feedback provision window 240. The folder list window 250 displays various folders generated by the user. The user can generate a folder for storing the selected drawing image, or for storing the representative image and the preview diagram, and the user can click on the folder to check the stored images, etc.

According to one embodiment of the present disclosure, design collaboration for a user's drawing design can be supported, by providing not only the drawing image for which the user has requested a search, but also a representative image and a preview diagram for the drawing image.

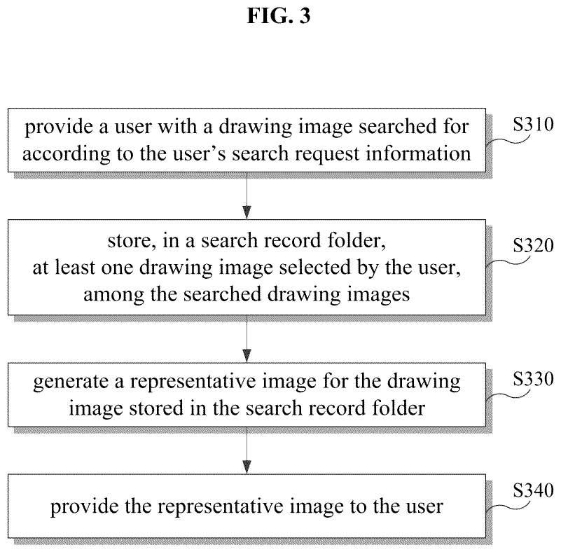

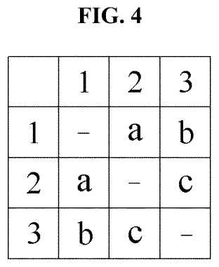

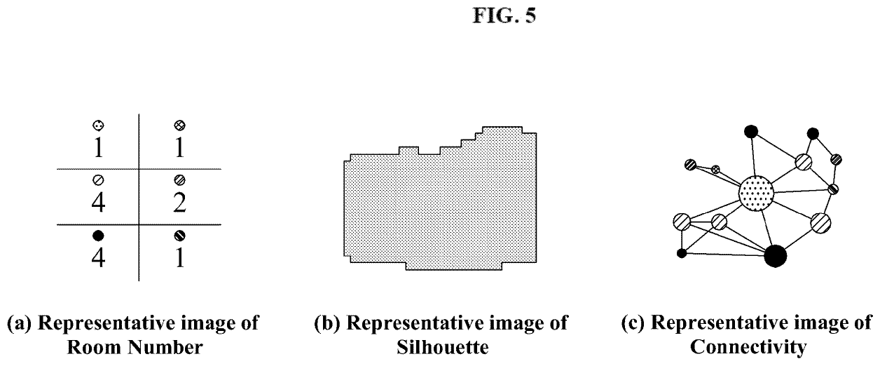

FIG. 3 is a drawing for explaining a method for providing drawing information for design collaboration according to one embodiment of the present disclosure, FIG. 4 is a drawing for explaining a method for generating a representative image with respect to a connectivity graph, and FIG. 5 is a drawing for explaining a representative image according to one embodiment of the present disclosure.

A method for providing drawing information according to one embodiment of the present disclosure may be performed in a computing device including a processor and a memory, and the above-described drawing information providing device is an example of a computing device.

Referring to FIG. 3, a computing device according to an embodiment of the present disclosure provides a user with a drawing image searched for according to the user's search request information (S310), and stores at least one drawing image selected by the user among the searched drawing images in a search record folder (S320).

Then, the computing device generates a representative image for the drawing image stored in the search record folder (S330) and provides the generated representative image to the user (S340). The computing device may generate a representative image for each type of attribute information of the drawing image stored in the search record folder.

In step S330, the computing device determines each of the maximum frequency groups from among the silhouette and connectivity groups of the drawing images stored in the search record folder. That is, the computing device may determine the group with the largest number of silhouette groups of the drawing images stored in the search record folder, and the group with the largest number of connectivity groups of the drawing images stored in the search record folder. In addition, when there are a plurality of maximum frequency groups, the computing device may randomly select one of the plurality of maximum frequency groups.

For example, if there are five drawing images stored in a search record folder, and the groups of silhouettes for each of the five drawing images are A, A, B, B, B, and the groups of connectivity are D, D, D, E, E, then the maximum frequency group for the silhouettes may be determined as B, and the maximum frequency group for connectivity may be determined as D. In addition, the computing device may also determine the maximum frequency group among the groups of number of rooms of the drawing images stored in the search record folder.

Then, the computing device generates a representative image for each silhouette and connectivity, from the silhouette and connectivity included in the maximum frequency group.

The computing device overlaps the images of the silhouettes included in the maximum frequency group to generate a representative image for the silhouette, and adds pixel values for each pixel of the images of the overlapped silhouettes. In the above-described example, the images of three silhouettes of group B are overlapped. The image of the silhouette may be, as an example, an image in which the pixel value inside the outline is 1 and the pixel value outside the outline is 0.

The computing device may generate a representative image for the silhouette, which is composed of an area where the average of the summed pixel values is greater than or equal to a preset threshold value. In the above-described example, the computing device may calculate an average value by dividing the summed pixel values by 3, which is the number of overlapping images, and generate a representative image composed of an area where the average value is greater than or equal to a threshold value of 0.5.

In addition, the computing device calculates a GED value for each pair of combinations consisting of each of the connectivity included in the maximum frequent group and the remaining connectivity included in the maximum frequent group, in order to generate a representative image of connectivity. That is, the computing device calculates a GED value between connectivity in a pair of combinations consisting of different connectivity.

Then, the computing device calculates a sum of GDE values for each combination group consisting of combinations including common connectivity.

In the above example, when the maximum frequency group is D, since there are three connectivity where the group is D, a table may be generated in which each of the connectivity (1, 2, 3) included in the maximum frequency group consists of a row and a column, as shown in FIG. 4. One of the connectivity of the row and one of the connectivity of the column constitute a pair of combinations, and each of the rows or columns corresponds to a combination group including the common connectivity. The GDE value (a, b, c) between the pair of connectivity can be calculated, and the computing device calculates the sum of the GED values of the rows or columns of the table.

The computing device generates a graph of connectivity commonly included in the combination group corresponding to the minimum value among the sum values as a representative image. In an example such as FIG. 4, if the sum of a and b is the minimum value, the computing device generates a graph of the first connectivity (1) commonly included in the combination group including the combination of the first connectivity (1) and the second connectivity (2) and the combination of the first connectivity (1) and the third connectivity (3) as a representative image for connectivity.

FIG. 5 shows representative images for the number of rooms ((a) Representative image of Room Number), silhouette ((b) Representative image of Silhouette), and connectivity ((c) Representative image of Connectivity) generated according to one embodiment of the present disclosure. The representative image for the number of rooms is a drawing showing the number of rooms of the maximum frequency group for the number of rooms, and the representative image for the silhouette may display an area in which the average value of pixel values is greater than or equal to a threshold value in gray. In FIG. 5, circles of different colors represent different types of rooms.

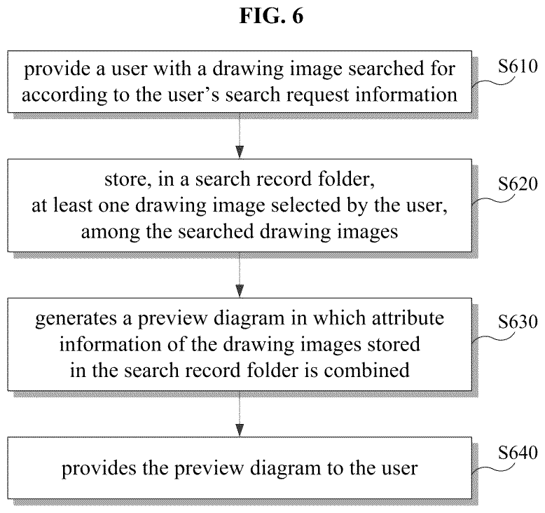

Meanwhile, a computing device according to one embodiment of the present disclosure may generate a preview diagram using the silhouette and connectivity of a drawing image stored in a search record folder, and provide the generated preview diagram to a user together with a representative image. A method of generating a preview diagram is described in FIG. 6.

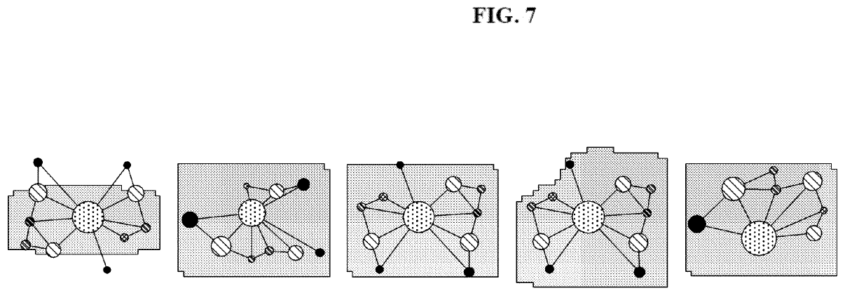

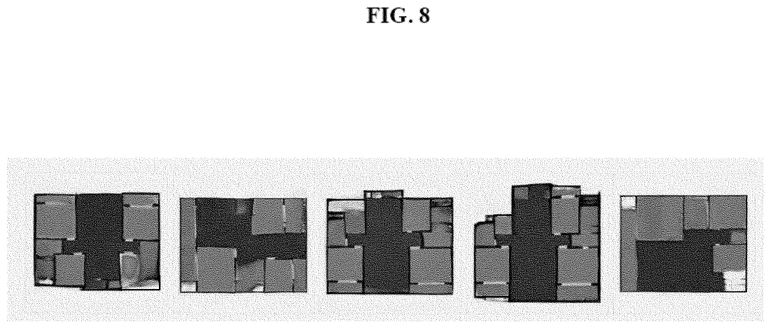

FIG. 6 is a drawing for explaining a method for providing drawing information for design collaboration according to another embodiment of the present disclosure, and FIG. 7 is a drawing for explaining a preview diagram according to one embodiment of the present disclosure. In addition, FIG. 8 is a drawing for explaining a drawing image converted from the preview diagram of FIG. 7.

Referring to FIG. 6, a computing device according to an embodiment of the present disclosure provides a user with a drawing image searched for according to the user's search request information (S610), and stores at least one drawing image selected by the user among the searched drawing images, in a search record folder (S620).

Then, the computing device generates a preview diagram in which attribute information of the drawing images stored in the search record folder is combined (S630) and provides the generated preview diagram to the user (S640). As described above, the attribute information assigned to the drawing image includes at least one of the number of rooms, silhouette, and connectivity, and the computing device generates a preset number of preview diagrams by combining such attribute information. FIG. 7 illustrates an example in which five preview diagrams are generated.

In step S630, the computing device selects at least one group from among the groups of each of the number of rooms, silhouettes, and connectivity of the drawing images stored in the search record folder, and overlaps the image of the silhouette and the graph of connectivity for the drawing images corresponding to the selected group to generate a preview diagram. Since the graph of connectivity here includes information about the number of rooms, the image for the number of rooms is not visualized separately.

For example, if there are five drawing images stored in a search record folder, and the groups of the number of rooms are F, F, G, H, I, respectively, the groups of silhouettes are A, A, B, B, B, and the groups of connectivity are D, D, D, E, E, then the computing device selects one group among F, G, H, I, one group among A, B, and one group among D, E. Then, the silhouette images and connectivity graphs for the drawing images stored in the search record folder corresponding to the selected group may be overlapped to generate a preview diagram as in FIG. 7. In this case, the overlapping image may be a representative image of the silhouette and connectivity included in the selected group.

The computing device may select at least one group from among the groups of each of the number of rooms, silhouettes, and connectivity, with a probability proportional to the frequency of groups of each of the number of rooms, silhouettes, and connectivity of the drawing images stored in the search record folder. In the example described above, since the frequency of F is the highest in the group of the number of rooms, the frequency of B is the highest in the group of silhouettes, and the frequency of D is the highest in the group of connectivity, the probability that the group F, the group B, and the group D will be selected may be set to be the highest. Accordingly, the representative image for the silhouette of the group B and the representative image for the connectivity of the group D may be overlapped to generate a preview diagram.

The computing device may select one group from each of the three types of attribute information of the drawing image stored in the search record folder, or select a pair of groups for two types of attribute information of the drawing image stored in the search record folder and select one group from the remaining types, according to a preset idea moderation level. Alternatively, the computing device may select a group of three types of attribute information of the drawing image stored in the search record folder.

For example, if there are five drawing images stored in a search record folder, and the groups for the number of rooms, silhouettes, and connectivity are respectively (A,B,C), (A,B,D), (A,B,E), (A,B,F), (A,B,C), then since the frequency of (A,B,C) is the highest, the computing device may overlap the representative image for the silhouette of group B with the representative image for the connectivity of group C, to generate a preview diagram.

Meanwhile, the computing device may transform the preview diagram into a drawing image using a pre-trained artificial neural network and provide the transformed drawing image to the user. As an example, the computing device may transform the preview diagram into a drawing image using StyleGAN2-ADA or a pixel2style2pixel neural network. FIG. 8 illustrates five drawing images transformed from the preview diagram of FIG. 7.

In addition, the computing device may transform a drawing image searched by a user into a new drawing image using the neural network described above.

The technical features described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

The specified matters and limited exemplary embodiments and drawings such as specific elements in the present invention have been disclosed for broader understanding of the present invention, but the present invention is not limited to the exemplary embodiments, and various modifications and changes are possible by those skilled in the art without departing from an essential characteristic of the present invention. Therefore, the spirit of the present invention is defined by the appended claims rather than by the description preceding them, and all changes and modifications that fall within metes and bounds of the claims, or equivalents of such metes and bounds are therefore intended to be embraced by the range of the spirit of the present invention.

What is claimed is:

1. A method for providing drawing information for design collaboration, including the steps of:
providing drawing images searched according to search request information of a user to the user;
storing, in a search record folder, at least one drawing image selected by the user among the searched drawing images;
generating a representative image with respect to the drawing image stored in the search record folder; and
providing the representative image to the user.

2. The method for providing drawing information for design collaboration according to claim 1,
wherein attribute information assigned to the drawing image includes at least one of the number of rooms, silhouette, and connectivity, and
each of the number of rooms, the silhouette, and the connectivity is attribute information clustered into a plurality of groups according to similarity.

3. The method for providing drawing information for design collaboration according to claim 2,
wherein the step of generating the representative image includes the steps of:
determining each of the maximum frequency groups among groups of each of the silhouette and connectivity of the drawing images stored in the search record folder; and
generating the representative image for each silhouette and connectivity, from the silhouette and connectivity included in the maximum frequency group.

4. The method for providing drawing information for design collaboration according to claim 3,
wherein the step of generating the representative image includes the steps of:
overlapping the images of the silhouette included in the maximum frequency group and summing pixel values for each pixel of the image of the overlapped silhouette; and
generating the representative image for the silhouette, which is composed of an area in which an average value of the summed pixel values is greater than or equal to a preset threshold value.

5. The method for providing drawing information for design collaboration according to claim 3,
wherein the step of generating the representative image includes the steps of:
calculating a GED (Graph Edit distance) value for each pair of combinations consisting of each of the connectivity included in the maximum frequent group and the remaining connectivity included in the maximum frequent group;
calculating sum values of GDE values for each of combination groups consisting of combinations including common connectivity; and
generating a graph of connectivity commonly included in a combination group corresponding to the minimum value of the sum values, as the representative image.

6. The method for providing drawing information for design collaboration according to claim 2,
further comprising the steps of:
generating a preview diagram, using the silhouette and connectivity of the drawing image stored in the search record folder, and
providing the preview diagram to the user.

7. The method for providing drawing information for design collaboration according to claim 6,
wherein the step of generating a preview diagram includes the steps of:
selecting at least one group from among the groups of each of the number of rooms, silhouettes, and connectivity of the drawing images stored in the search record folder, and
overlapping the image of the silhouette and graph of connectivity for the drawing images corresponding to the selected group, to generate the preview diagram.

8. The method for providing drawing information for design collaboration according to claim 7,
wherein the step of selecting at least one group from among the groups of each of the number of rooms, silhouettes, and connectivity includes selecting at least one group, with a probability proportional to a frequency of groups of each of the number of rooms, silhouettes, and connectivity of the drawing images stored in the search record folder.

9. The method for providing drawing information for design collaboration according to claim 6,
including the steps of
transforming the preview diagram into a drawing image, using a pre-trained artificial neural network and
providing the transformed drawing image to the user.

10. A method for providing drawing information for design collaboration, including the steps of:
providing drawing images searched according to search request information of a user to the user;
storing, in a search record folder, at least one drawing image selected by the user, among the searched drawing images;
generating a preview diagram in which attribute information of the drawing images stored in the search record folder is combined; and
providing the preview diagram to the user,
wherein the attribute information assigned to the drawing image includes at least one of the number of rooms, silhouette, and connectivity, and
each of the number of rooms, silhouette image, and connectivity graph is attribute information clustered into a plurality of groups according to similarity.

11. The method for providing drawing information for design collaboration according to claim 10,
wherein the step of generating a preview diagram includes the steps of:
selecting at least one group from among the groups of each of the number of rooms, silhouettes, and connectivity of the drawing images stored in the search record folder, and
overlapping the image of the silhouette and the graph of connectivity for the drawing images corresponding to the selected group, to generate the preview diagram.

12. The method for providing drawing information for design collaboration according to claim 11,
wherein the step of selecting at least one group from among the groups of each of the number of rooms, silhouette images, and connectivity graphs includes
selecting at least one group, with a probability proportional to a frequency of groups of each of the number of rooms, silhouettes, and connectivity of the drawing images stored in the search record folder.

13. The method for providing drawing information for design collaboration according to claim 10,
further including the steps of
transforming the preview diagram into a drawing image, using a pre-trained artificial neural network and
providing the transformed drawing image to the user.

14. A device for providing drawing information for design collaboration, comprising:
a memory; and
at least one processor electrically connected to the memory,
wherein the processor
stores, in a search record folder, at least one drawing image selected by a user, among drawing images searched according to search request information of the user, and
generates a representative image with respect to the drawing image stored in the search record folder and a preview diagram in which attribute information of the drawing images stored in the search record folder is combined.
